(19) United States
(12) Patent Application Publication
(10) Pub. No.: US 2007/0103895 A1
(43) Pub. Date: May 10, 2007

(54) Illumination System For Portable Insulated Containers

(76) Inventor: Scott Riesebosch, Welland, Ontario (CA)

Correspondence Address: SCOTT RIESEBOSCH, 129 HAGAR ST., UNIT # 5, WELLAND, ON, L3B-5V9, CA

(21) Appl. No.: 11/164,075

(22) Filed: Nov. 9, 2005

(51) Int. Cl. F21V 33/00

(52) U.S. Cl. 362/154; 362/276; 362/183

(57) ABSTRACT

There is provided a new and useful illumination system for use on portable insulated containers that do not have onboard or self-contained powered cooling systems. The illumination system will illuminate the contents of the container when the lid is opened.

### FIELD OF THE INVENTION

This invention relates to an illumination system to illuminate the contents of portable insulated containers that do not have a self-contained or onboard cooling system.

### BACKGROUND OF THE INVENTION

Insulated containers, also called “coolers,” are commonplace in modern life. The insulated containers are often used to keep drinks and food cool for picnics or for outdoor activities such as camping or sporting events. In addition, insulated containers are becoming more prevalent in the medical industry, where they are used to move transplant organs and other articles that need to remain cold during transport. One downside to modern day coolers is that only more expensive models with powered cooling systems onboard have lighting systems in them. These lighting systems illuminate the contents of the cooler when the lid is opened, but they use power from the power supply that runs the onboard electrical cooling system. Users with less expensive models that rely on ice packs or cubes to cool the contents must rely on external or ambient lighting to view the contents of their cooler.

There exists a need for a system that will illuminate the contents of these traditional coolers that do not have self-contained, powered cooling systems. Since this type of cooler does not have power supplied to it for the cooling system, the illumination system would need to have a source of power such as a battery, power plug, or solar cell. It would also need to automatically turn on when the lid is open.

An additional feature that would be useful would be a means of automatically turning off the light if the lid has been left open for a pre-determined length of time. If the power source is a battery, this would keep the battery from discharging if the lid was accidentally left open. A manual selector switch could also allow the user to set the desired mode of operation, allowing them to simply turn the light on or off at their discretion.

Another feature that could be incorporated into the illumination system is a photo-sensor that would detect ambient light levels. If the ambient light is above a pre-determined level, the illumination system would not turn on the light because it would not be necessary. If the system is powered by a battery, this feature would help to extend the life of the battery.

### SUMMARY OF THE INVENTION

It is thus the object of the present invention to provide an illumination system for use on portable insulated containers that do not have onboard powered cooling systems, to illuminate the contents of the container when the lid is opened. It is a further object of the present invention to provide a means for automatically turning off the light source if the lid has been left open beyond a pre-determined period of time to help extend the battery life. It is a further object of the present invention to provide means for sensing ambient light levels, allowing the system to turn on the light only when the ambient light levels are not high enough to provide adequate illumination of the contents of the container. It is a further object of the present invention to provide power to the illumination system from a battery mounted within the container, a power adaptor that can be plugged into an external power source, or a solar cell used to charge a battery mounted within the container.

### BRIEF DESCRIPTION OF DRAWINGS

FIG. 1 is a side cutaway view of an insulated container fitted with the illumination system according to the present invention. In FIG. 1, the light source is indicated generally as 1. The principal elements of the invention are the light source 1, lid 2, insulated container 3, power source 4, solar cell 5, ambient light level sensor 6, and the contents of the container 7.

### DETAILED DESCRIPTION

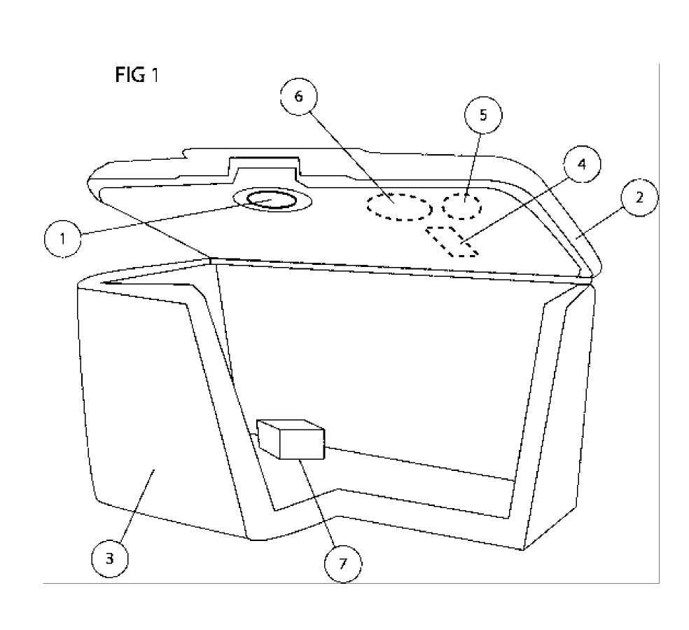

In one aspect of the invention, there is provided an illumination system for use in an insulated container designed to cool the contents of the container using only ice cubes or ice packs, without the aid of a power-consuming cooling system. The illumination system is arranged so it is normally off, and will turn on a light inside when the lid of the insulated container is opened. In FIG. 1, the normal light location is on the under side of the lid of the container, indicated generally as 1. When the lid of the container indicated as 2, is opened, the light 1 is turned on to illuminate the contents, indicated generally as 7. If the lid 2 is left open for an extended period of time, the light 1 is extinguished automatically to preserve the life of the power source 4. If the ambient light level striking the ambient light level sensor 6 is above a pre-determined level, the system will not illuminate the light 1 when the lid 2 is opened. The solar cell 5 is mounted to the outside of the insulated container and provides a charging current to the power source 4.

What is claimed is:

1. An illumination system to illuminate the contents of an insulated container when the lid of said container is opened, wherein the cooling means within the container do not require electrical power.

2. The illumination system of claim 1 wherein the power source for illuminating the contents of the insulated container is a battery.

3. The illumination system of claim 1 wherein the power source for illuminating the contents of the insulated container is a power adaptor that can be plugged into external sources of electricity.

4. The illumination system of claim 1 wherein the power source for illuminating the contents of the insulated container is a solar cell.

5. The illumination system of claim 1 wherein a light level sensor is used to sense ambient light levels to allow the system to determine if the ambient light will be sufficient to illuminate the contents of the insulated container when the lid is opened.

6. The illumination system of claim 1 wherein the system will automatically turn off the illumination means if the lid of the insulated container is left in the open position for longer than a pre-determined period of time.

7. The illumination system of claim 1 wherein the illumination means is an LED or array of LEDs mounted at a location inside the insulated container.

8. The illumination system of claim 1 wherein a manual switch will allow the user to turn the light on or off.
